(19) United States
(12) Patent Application Publication
(10) Pub. No.: US 2020/0328625 A1
(43) Pub. Date: Oct. 15, 2020

(54) OBJECT DETECTION IN WIRELESS POWER TRANSFER SYSTEM

(71) Applicant: KONINKLIJKE PHILIPS N.V., Eindhoven (NL)

(72) Inventor: John Brean MILLS, Eindhoven (NL)

(21) Appl. No.: 16/090,672

(22) PCT Filed: Mar. 27, 2017
(86) PCT No.: PCT/EP2017/057142

§ 371 Date: Oct. 2, 2018

(30) Foreign Application Priority Data
Apr. 6, 2016 (EP) 16163960.4

(51) Int. Cl. H02J 50/60; H02J 50/12; H04B 5/00; G01V 3/10

(52) U.S. Cl. CPC H02J 50/60; H02J 50/12; G01V 3/101; H04B 5/0043; H04B 5/0037

(57) ABSTRACT

A power transmitter (22) for a wireless power transfer system comprises an output circuit comprising a transmit power inductor (25) generating a wireless power transfer signal. An object detector (43) for detection of an object extracting power from the power transfer signal includes a signal generator (501) generating first and second carrier signals. A first signal path (503) receives the first carrier signal and comprises a circulator (513) having a port coupled to the output circuit and a port providing a reflected signal from the output circuit. A second signal path (505) receives the second carrier signal and has a signal path equalizer (515) with a transfer function corresponding to a transfer function of the circulator (513). A mixer (507) mixes signals from the two signal paths (503) and a first detector (509) determines a reflection parameter for the output circuit in response to the mixed signal. A second detector (511) detects a presence of the object in response to the reflection parameter.

### FIELD OF THE INVENTION

The invention relates to object detection in wireless power transfer system and in particular, but not exclusively, to detection of foreign objects in a Qi compatible wireless power transfer system.

### BACKGROUND OF THE INVENTION

Determination of impedances of circuits or components is of high importance in many applications and systems. In particular, real time and in circuit impedance determination can in many applications and systems improve or enable functionality and services provided.

An example of a system in which impedance determination may be advantageous is a wireless power transfer system. Inductive wireless power transfer is becoming increasingly popular. In this technology, a power transmitter device generates a magnetic field using a primary coil. A power receiver device taps energy from this magnetic field using a secondary coil, inductively coupled to the primary coil by close proximity. This power is transferred without making electrical contact. One such technology has been defined by the Wireless Power Consortium, and is known under the name of Qi.

In an application example of this technology, a mobile phone acts as the power receiver and has a secondary coil built in. For charging of the phone's batteries, it is placed on the surface of a wireless charging pad that has a primary coil built in. The two coils are coupled by proper placement of the phone on the charging pad, and power is transferred from the charger to the phone wirelessly by induction. In this way, the phone can be charged by simply placing it on a dedicated charger surface, without the need for attaching connectors and wires to the phone. The charging of a mobile phone or other portable device is a low-power application, with typically about 1 to 5 watt of power being transferred from transmitter to receiver. High-power applications of inductive wireless power transfer may be used for cooking food or even charging an electrical car wirelessly.

A potential problem with wireless power transfer is that power may unintentionally be transferred to e.g. metallic objects. For example, if a foreign object, such as e.g. a coin, key, ring etc., is placed upon the power transmitter platform arranged to receive a power receiver, the magnetic flux generated by the transmitter coil will introduce eddy currents in the metal objects which will cause the objects to heat up. The heat increase may be very significant and may be highly disadvantageous.

In order to reduce the risk of such scenarios arising, it has been proposed to introduce foreign object detection where the power transmitter can detect the presence of a foreign object and reduce the transmit power and/or generate a user alert when a positive detection occurs. For example, the Qi system includes functionality for detecting a foreign object, and for reducing power if a foreign object is detected.

One method to detect such foreign objects is by determining power losses, as e.g. disclosed in WO 2012127335. Both the power receiver and the power transmitter measure their power, and the receiver communicates its measured received power to the power transmitter. When the power transmitter detects a significant difference between the power sent by the transmitter and the power received by the receiver, an unwanted foreign object may potentially be present, and the power transfer may be reduced or aborted for safety reasons. This power loss method requires synchronized accurate power measurements performed by power transmitter and power receiver.

For example, in the Qi power transfer standard, the power receiver estimates its received power e.g. by measuring the rectified voltage and current, multiplying them and adding an estimate of the internal power losses in the power receiver (e.g. losses of the rectifier, the receive coil, metal parts being part of the receiver etc.). The power receiver reports the determined received power to the power transmitter with a minimum rate of e.g. every four seconds.

The power transmitter estimates its transmitted power, e.g. by measuring the DC input voltage and current of the inverter, multiplying them and correcting the result by subtracting an estimation of the internal power losses in the transmitter, such as e.g. the estimated power loss in the inverter, the primary coil and metal parts that are part of the power transmitter.

The power transmitter can estimate the power loss by subtracting the reported received power from the transmitted power. If the difference exceeds a threshold, the transmitter will assume that too much power is dissipated in a foreign object and it can then proceed to terminate the power transfer.

Alternatively, it has been proposed to measure the quality or Q-factor of the resonant circuit formed by the primary and secondary coils, and their capacitances and resistances. A reduction in the measured Q-factor may be indicative of a foreign object being present.

However, such algorithms tend to be suboptimal and may in some scenarios and examples provide less than optimum performance. In particular, they may result in foreign objects that are present not being detected, or in false detections of foreign objects when none are present.

Hence, an improved object detection would be advantageous and in particular an approach allowing increased flexibility, reduced cost, reduced complexity, improved object detection, fewer false detections and missed detections, and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided power transmitter for a wireless power transfer system including a power receiver for receiving a power transfer from the power transmitter via a wireless inductive power signal; the power transmitter comprising: an output circuit comprising a transmit power inductor for generating the wireless inductive power signal; an object detector for detection of an object extracting power from the power transfer signal; wherein the object detector comprises: a signal generator for generating a first carrier signal and a second carrier signal, the second carrier signal having a frequency offset relative to the first carrier signal; a first signal path coupled to the signal generator so as to receive the first carrier signal, the first signal path comprising a first circulator having a first port coupled to the signal generator for receiving the first carrier signal and a second port coupled to the output circuit and a third port providing a reflected signal from the output circuit; a second signal path coupled to the signal generator so as to receive the second carrier signal, the second signal path comprising a signal path equalizer having a transfer function corresponding to a transfer function of at least a signal path from the first port to the third port of the first circulator; a mixer coupled to the first signal path and the second signal path and arranged to generate a mixed signal by mixing an output signal from the first signal path and an output signal from the second signal path; a first detector for determining a reflection parameter for the output circuit in response to the mixed signal; and a second detector for detecting a presence of the object in response to the reflection parameter.

The approach may provide improved operation in many scenarios, and may in particular allow improved and/or a more accurate (foreign) object detection. The approach may provide an efficient compensation for variations in the circuitry of the object detector, such as specifically compensation for variations in component tolerances, path length differences, etc. Accordingly, a more accurate indication of the reflection parameter may be obtained and thus a more accurate object detection can be achieved.

The approach may allow for relatively low complexity implementation and/or processing while achieving high performance. The object detector approach is particularly flexible and suitable for implementation substantially in the digital domain (e.g. using a microcontroller) or in the analogue domain. A particularly advantageous approach may allow the signal paths and mixer to be performed in the analogue domain with the second, and typically also the first, detector being implemented in the digital domain.

The object detector may specifically be arranged to detect an object other than the power receiver extracting power from the power transfer signal. The object detector may be arranged to perform foreign object detection.

The first and second carrier signals may be substantially single tone (sinewave) signals. In many embodiments, the first and second carrier signals may have no less than 70%, 80%, 90%, 95% or 99% of energy/power concentrated in a first harmonic or single frequency. For the first circulator, the second port may be the output for the first port and the third port may be the output for the second port. In other embodiments, other intermediate ports may be present (e.g. the reflected signal on the second port may reach the third port via an intermediate port which reflects all or part of the reflected signal of the second port).

The transfer function of the signal path equalizer may be set to be substantially the same as a transfer function from the first port to the third port. In some embodiments, the transfer function of the signal path equalizer may include compensation of other elements, and specifically of other sections of the first signal path. Thus, in some embodiments, the transfer function of the signal path equalizer may be a combination of a plurality of transfer functions one of which may correspond to the transfer function of the signal path from the first port to the third port of the first circulator. The transfer function of the signal path equalizer may comprise at least one partial transfer function corresponding to the transfer function from the first port to the third port. The at least one partial transfer function may be a match to the transfer function from the first port to the third port,

The signal path equalizer may include circuitry being at least a partial copy of circuitry of the first circulator, the circuitry corresponding to circuitry of the circulator in the signal path from the first to the third port.

The signal path equalizer may have a transfer function such that the (overall) transfer function of the second signal path corresponds to/matches the (overall) transfer function of the first signal path.

In many embodiments, the output signal from the first signal path may be the signal of the third port of the first circulator and the output signal from the second signal path may be the output of the signal path equalizer 515. The output signal from the first signal path comprises at least a signal component corresponding to the reflected signal. In many embodiments, the mixer may be arranged to generate a mixed signal by mixing the reflected signal (or a signal comprising the reflected signal) from the first signal path and an output signal from the signal path equalizer.

The reflection parameter may be a parameter indicative of how much the impedance provided by the output impedance differs from a reference impedance of the first circulator. The reflection parameter may be a parameter indicative of an impedance or admittance of the output circuit. The reflection parameter may be an impedance parameter or may be a network parameter such as an S-parameter.

The reflection parameter may be a complex value and may specifically represent a complex impedance of the output circuit.

In accordance with an optional feature of the invention, the signal path equalizer comprises at least two circulator stages coupled in cascade, a first circulator stage of the at least two circulator stages corresponding to a circulator stage from the first port to the second port of the first circulator and a second circulator stage of the at least two circulator stages corresponding to a circulator stage from the second port to the third port of the first circulator.

This may provide improved accuracy in many embodiments and may in many scenarios allow efficient and facilitated implementation while providing a very accurate equalization between the first and second signal paths.

A circulator stage provides the signal processing from one port to the next, e.g. from the first port to the second port. A circulator stage may have a transfer function corresponding to a substantially fixed non-zero gain for a reflected signal on the input port and to a substantially zero gain for an output signal on the input port.

In accordance with an optional feature of the invention, the signal path equalizer comprises at least one circulator.

This may provide facilitated implementation and may allow a highly accurate compensation and equalization between the first and second signal paths. This may further provide improved accuracy in the detection of the reflection parameter and thus in improved foreign object detection.

The at least one circulator may have circulator stages which are substantially identical to the circulator stages of the first circulator.

In accordance with an optional feature of the invention, the signal path equalizer comprises two cascade coupled circulators.

This may provide a particularly efficient and high performing approach. Specifically, it may allow efficient equalization by providing a signal processing of the second signal path which is a close match to the signal processing of the first signal path. It may further provide suitable terminations etc. for the different elements of the system thereby reducing unintended reflections etc.

In accordance with an optional feature of the invention, the first circulator is a four port circulator having a reference impedance coupled to a fourth port and the two cascade coupled circulators are three port circulators each having a reference impedance coupled to a third port.

This may provide a particularly efficient system, and may e.g. reduce the requirements for other circuit elements, such as the mixer etc.

In accordance with an optional feature of the invention, the first circulator is an active circulator.

The system may utilize active circulators comprising an amplification element between consecutive ports. The approach may allow a practical object detector to be based on circulator concepts typically known from microwave implementations. The approach may allow the object detection to be based on low RF frequencies rather than e.g. microwave frequencies.

The circulator stages may comprise amplification circuitry, such as operational amplifiers, that are arranged to generate an output signal (e.g. for the output port being terminated by a matched impedance) which corresponds to the output signal of the input port multiplied by a reflection coefficient for this port.

In accordance with an optional feature of the invention, the signal generator is arranged to generate the first and second carrier signals as a varied frequency carrier signals; and the first detector is arranged to determine the reflection parameter as a frequency dependent reflection parameter.

The approach may allow an effective characterization of the output circuit which may allow improved information that enables an improved accuracy for the foreign object detection.

In accordance with an optional feature of the invention, the signal generator is arranged to generate the first carrier signal and the second carrier signal to not have a frequency exceeding 10 MHz.

The approach may allow foreign object detection to be based on circulator based measurements performed at frequencies suitable for wireless power transfer systems. It may allow lower complexity and simpler circuitry yet provide a high degree of accuracy in detection.

In accordance with an optional feature of the invention, the second detector is arranged to determine component parameters for an electric circuit model in response to the reflection parameter; and to detect the presence of the object in response to the component parameters.

The approach may provide an improved characterization of the output circuit and thus an improved object detection. The approach may allow an improved separation between effects that may be due to the presence of a power receiver and effects that are due to the presence of a foreign object.

In accordance with an optional feature of the invention, the electric circuit model is a lossy Foster reactance model.

This model provides particularly advantageous modelling of the output circuit for object detection in a wireless power transfer system.

In accordance with an optional feature of the invention, the4 power transmitter is arranged to receive circuit data from the power receiver, the circuit data being indicative of a receiving circuit of the power receiver; and to determine at least one of the electric circuit model and a criterion for detecting the presence of the object in response to the circuit data received from the power receiver.

This approach may allow improved foreign object detection. In particular, it may allow improved compensation for the effects of the power receiver when evaluation if a foreign object is present or not.

In accordance with an optional feature of the invention, a frequency of the power transfer signal is not above 200 kHz and a frequency of the first carrier signal is not below 500 kHz.

This may provide improved performance in many embodiments, and may allow efficient interworking and co-existence for functionality for power transfer and functionality for object detection.

In accordance with an optional feature of the invention, the power transmitter of claim 1 further comprising a calibrator arranged to couple a known load to the second port of the first circulator instead of the output circuit and to calibrate the object detector in response to a parameter of the object detector when the known load is coupled to the second port.

An advantage of the approach is that it may allow a particularly efficient and accurate calibration thereby resulting in improved foreign object detection. The known load may for example be a short-circuit, and/or and open circuit.

According to an aspect of the invention there is provided a wireless power transfer system comprising a power transmitter and a power receiver for receiving a power transfer from the power transmitter via a wireless inductive power signal; the power transmitter comprising: an output circuit comprising a transmit power inductor for generating the wireless inductive power signal; an object detector for detection of an object extracting power from the power transfer signal; wherein the object detector comprises: a signal generator for generating a first carrier signal and a second carrier signal, the second carrier signal having a frequency offset relative to the first carrier signal; a first signal path coupled to the signal generator so as to receive the first carrier signal, the first signal path comprising a first circulator having a first port coupled to the signal generator for receiving the first carrier signal and a second port coupled to the output circuit and a third port providing a reflected signal from the output circuit; a second signal path coupled to the signal generator so as to receive the second carrier signal, the second signal path comprising a signal path equalizer having a transfer function corresponding to a transfer function of at least a signal path from the first port to the third port of the first circulator; a mixer coupled to the first signal path and the second signal path and arranged to generate a mixed signal by mixing an output signal from the first signal path and an output signal from the second signal path; a first detector for determining a reflection parameter for the output circuit in response to the mixed signal; and a second detector for detecting a presence of the object in response to the reflection parameter.

According to an aspect of the invention there is provided a method of operation for a power transmitter for a wireless power transfer system including a power receiver for receiving a power transfer from the power transmitter via a wireless inductive power signal; the power transmitter comprising: an output circuit comprising a transmit power inductor for generating the wireless inductive power signal; an object detector for detection of an object extracting power from the power transfer signal; and the method comprising the object detector performing the steps of: generating a first carrier signal and a second carrier signal, the second carrier signal having a frequency offset relative to the first carrier signal; providing a first signal path coupled to the signal generator so as to receive the first carrier signal, the first signal path comprising a first circulator having a first port coupled to the signal generator for receiving the first carrier signal and a second port coupled to the output circuit and a third port providing a reflected signal from the output circuit; providing a second signal path coupled to the signal generator so as to receive the second carrier signal, the second signal path comprising a signal path equalizer having a transfer function corresponding to a transfer function of at least a signal path from the first port to the third port of the first circulator; generating a mixed signal by mixing an output signal from the first signal path and an output signal from the second signal path; determining a reflection parameter for the output circuit in response to the mixed signal; and detecting a presence of the object in response to the reflection parameter.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a wireless power transfer system;

FIG. 2 illustrates an example of a wireless power transfer system;

FIG. 3 illustrates an example of elements of coupling circuits for a power transmitter and a power receiver of a wireless power transfer system;

FIG. 4 illustrates an example of elements of a power transmitter in accordance with some embodiments of the invention;

FIG. 5 illustrates an example of elements of a power transmitter in accordance with some embodiments of the invention;

FIG. 6 illustrates an example of elements of a power transmitter in accordance with some embodiments of the invention;

FIG. 7 illustrates an example of an active circulator circuit;

FIG. 8 illustrates an example of a lossy Foster reactance model;

FIG. 9 illustrates an example of elements of a power transmitter in accordance with some embodiments of the invention; and

FIGS. 10-13 illustrates comparative measurements of a active four port circulator and two cascade coupled active three port circulators.

### DETAILED DESCRIPTION OF SOME EMBODIMENTS OF THE INVENTION

The following description focuses on embodiments of the invention applicable to a wireless power transfer system and in particular to a wireless power transfer system in accordance with the Qi Specifications. In particular, the following description will focus on determination of a reflection parameter (such as an impedance, admittance, S parameter or any other suitable network parameter) of a port which corresponds to an output circuit of a power transmitter for wireless power transfer. The reflection parameter is used to perform foreign object detection. However, it will be appreciated that the invention is not limited to this application but may be applied to many other systems and in many other applications.

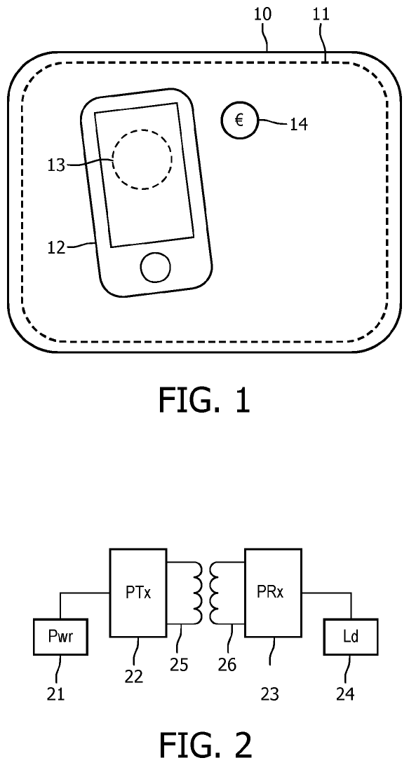

FIG. 1 illustrates an example of a wireless power transfer application. A mobile device 12 is placed on the surface of a wireless charging pad 10. The illustrated charging pad is merely a practical example and charging pads or supports may come in many forms. For example, a wireless power source/transmitter may be provided as a separate device, or may e.g. be part of a car dashboard, or built into a work top surface or integrated in a piece of furniture etc. The charging pad in this example is equipped with a single primary coil 11, and acts as an inductive wireless power transmitter. The mobile device is equipped with a secondary coil 13, and acts as an inductive wireless power receiver. The charging pad sends an alternating current through a coil (referred to as a transmitter power coil or a primary coil) which causes an alternating magnetic field to be generated. This magnetic field in turn induces an alternating voltage and current in a coil of the power receiver (referred to as the receiver power coil or the secondary coil), which may be rectified and used to e.g. charge the batteries of the mobile device. Thus, power is wirelessly transferred from the charger to the mobile device, as an inductive wireless power signal, referred to as a power transfer signal. The principle is similar to a traditional transformer, but with much weaker coupling, and the primary and secondary coils now reside in separate devices.

Typically, the amount of power to be transferred is around 1 to 5 watt for small mobile devices such as mobile phones, depending on the application and on the requirements of the receiver. The power may be much higher, for example in kitchen applications that may provide power levels of 1000 watt or more. A secondary coil of a wireless power receiver in such applications will typically have a size suitable for a portable device, say 1 to 15 cm in diameter for devices ranging from smart watches to kitchen appliances. The primary coil is typically approximately the same size, or may be larger in order to accommodate multiple receivers, as illustrated in FIG. 1. Instead of a single large primary coil, a number of smaller primary coils in series or in parallel may also be used. In FIG. 1, a foreign object 14 is shown, placed on the surface of the charging pad. The foreign object 14 may be a metallic object such as a coin or keys. The alternating magnetic field generated by the charging pad will induce eddy currents in the foreign metal object, which may cause the object to heat up. This could make the object uncomfortable to touch, or it could lead to damage to the charging pad. In order to avoid such situations, it is therefore desirable to detect the presence of such objects. For example, detecting a foreign object can result in the power level of the power transmitter being reduced to very low levels (or even being switched off) thereby preventing excessive heating of the object. Alternatively, or additionally, an audible and/or visible alarm may attract the attention of a user and advise removal of the object.

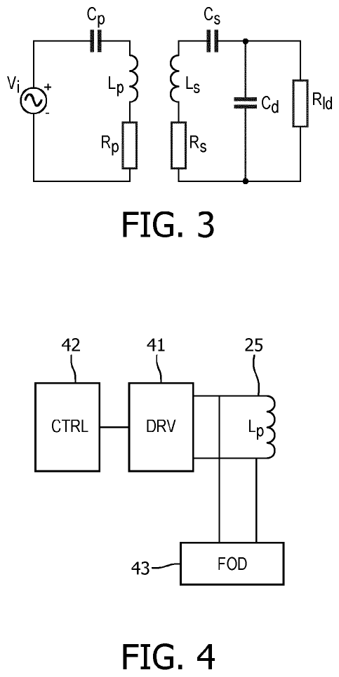

FIG. 2 schematically illustrates elements of a wireless power transfer system including an inductive wireless power transmitter 22 (PTx) inductively coupling to an inductive wireless power receiver 23 (PRx). The power transmitter comprises a primary coil 25, and obtains power from a power source 21, which may for example be the mains electricity. The power receiver 23 comprises a secondary coil 26 in which the generated power transfer signal induces a current and thus a power. The power receiver 23 is arranged to extract power from the power transfer signal and provide it to a load 24 (as well as power itself from the power transfer signal). The load may for example be a battery that is to be charged, but many other options are possible, for example an electromotor may be powered, or a resistive element may be powered for heating purposes etc.

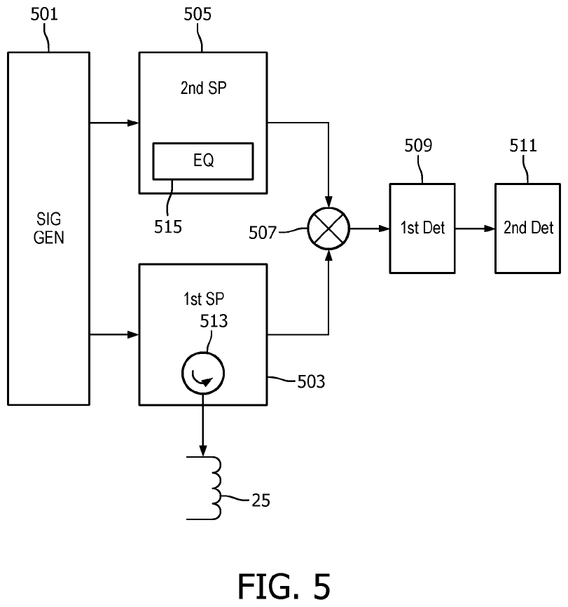

FIG. 3 schematically illustrates some equivalent electrical components of an inductive wireless power transmitter and receiver, and specifically FIG. 3 illustrates elements of the power transfer path. In the example, the power transmitter generates (e.g. using an output inverter stage) a drive signal in the form of an AC voltage Vᵢ. The drive signal is fed to an output circuit which includes a primary coil 25 (Lₚ) that generates the inductive power transfer signal.

The primary coil 25 forms an inductor Lₚ. In practice the primary coil 25 and other parts of the primary circuit will have a certain resistance, represented by Rₚ. A capacitor Cₚ is commonly included to generate a resonance circuit as the output of the power transmitter 23, The capacitor Cₚ is chosen to result in the desired resonance frequency of the primary circuit determined by Lₚ and Cₚ. This resonance frequency is typically set to be equal to the resonance frequency of the secondary circuit, and the system is operated with the frequency of the input voltage Vᵢ substantially at that resonance frequency in order to optimize efficiency of the power transfer.

The secondary circuit (the power receiving circuit of the power receiver) similarly comprises a resonance circuit which in FIG. 3 is formed by an inductor Lₛ corresponding to the secondary coil, a resistance Rₛ, (representing losses etc) and a capacitor Cₛ. The power received by the secondary coil 26 is supplied to a load, represented by R_{1d}. The main resonance frequency of the secondary circuit is determined by Lₛ and Cₛ.

The frequency of the power transfer signal is typically set in the range from 20 kHz to 200 kHz for wireless power transfer systems transferring power levels over, say, 1 W. In many systems, the drive frequency (and thus the frequency of the power transfer signal) as well as the resonance frequencies are set to substantially the same frequency. For example, they may all be set to 100 kHz for a Qi system.

FIG. 3 further illustrates that a second capacitor C_{d} may in some embodiments be added to the receiver resonance circuit in order to provide a second resonance frequency determined by Lₛ, Cₛ and C_{d}. This second resonance frequency may typically be set to be substantially higher than the main power transfer resonance frequency. For example, for a system compatible with the Qi standard, the second resonance frequency may be set to approximately 1 MHz. This second capacitor C_{d} may in some embodiments be connected through a switch so it can be disconnected when not needed.

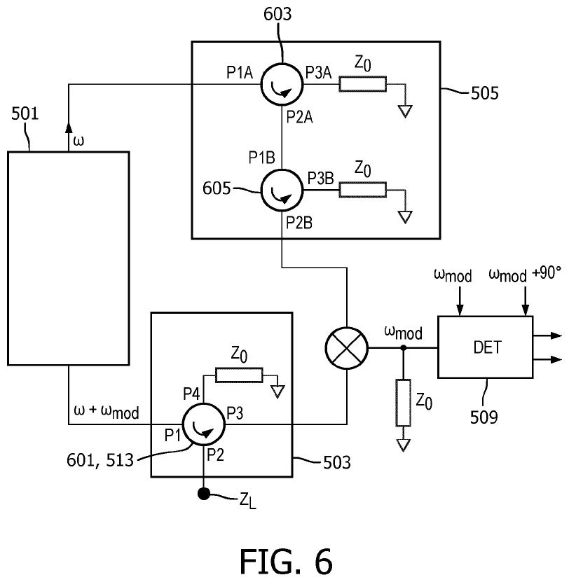

FIG. 4 illustrates an example of some elements of a power transmitter in accordance with some embodiments of the invention.

In the example, the power transmitter comprises the primary coil 25 which is driven by a driver 41 to generate the power transfer signal. Thus, the driver 41 generates a drive signal which is fed to the primary coil 25 resulting in an inductive signal being generated which may then induce a current in the secondary coil 26 thereby transferring power to the power receiver 23.

The driver 41 may specifically comprise an inverter comprising a full or half bridge switch output circuit as will be known to the skilled person.

The power transmitter further comprises a transmit controller 42 which is arranged to control the operation of the power transmitter 22 and specifically is arranged to control the power transmitter 22 to perform the required functions for initializing and supporting a power transfer.

The power transmitter 22 further comprises an object detector 43 which is arranged to detect whether a (foreign) object is present or not. The object detector 43 is in the example coupled directly to the primary coil 25. However, it will be appreciated that in other embodiments, the object detector 43 may be coupled to an output circuit which also includes other components than the primary coil 25, such as for example to a resonance circuit including the primary coil 25 as well as one or more capacitors (Cₚ). Indeed, the output of the driver 41 may be considered to be part of an output circuit of the power transmitter being sensed by the object detector 43.

The object detector 43 is arranged to perform the foreign object detection based on monitoring a property of the output circuit to which it is coupled. Specifically, the object detector 43 is arranged to determine a reflection parameter for a signal fed to the port formed by the output circuit. It may then determine whether an object is present or not dependent on this reflection parameter. The reflection parameter may be indicative of a deviation of an impedance provided by the output circuit from a characteristics impedance (which specifically is the output impedance of the object detector 43). The reflection parameter may specifically be determined as an impedance parameter but could also be an admittance parameter, a scattering parameter, or indeed any other suitable network parameter or suitable port parameter.

As the output circuit comprises, or indeed consists of, the primary coil 25, the reflection parameter determined by the object detector 43 will depend on the current operating conditions and properties of the primary coil 25, and specifically it may depend on the impedance provided by this. As the loading of the power transfer signal varies depending on the presence or not of a metallic object, the impedance of the primary coil 25 will vary in dependence on whether such an object is present or not. The approach of FIG. 4 wherein a reflection parameter is determined and used to perform a foreign object detection has been found to provide a highly advantageous approach for evaluating the operating conditions of the primary coil 25, and specifically for detecting whether these reflect a foreign object being present or not.

The object detector 43 uses a very specific approach for performing the foreign object detection. The approach is based on a specific approach for determining a reflection parameter of the output circuit and accordingly the object detector 43 is arranged to provide a signal to the output circuit and to determine the impact of the output circuit on this signal. The energy/signal reflected back from the unknown load (of the output circuit) may be analyzed. The signal reflection can be considered to reflect how much the output circuit deviates from being a reference impedance/matched load for the object detector 43.

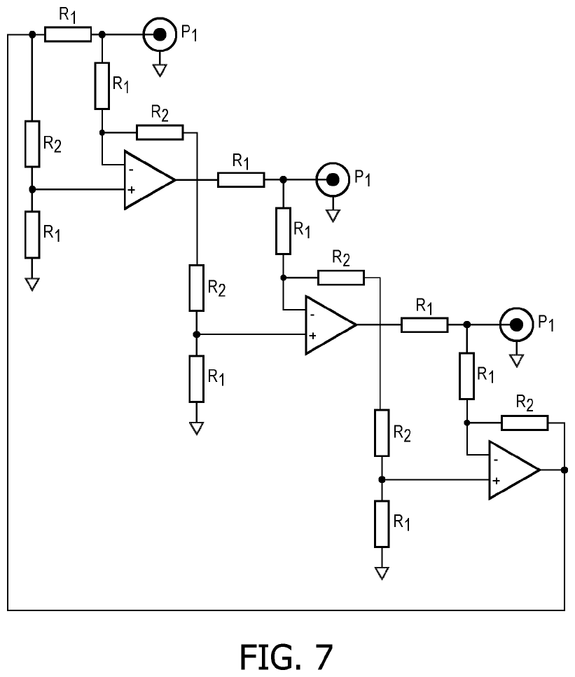

FIG. 5 illustrates examples of the object detector 43 in more detail. The object detector 43 determines a reflection parameter for a load or port which in the specific example is the primary coil 25 and which more generally may be an output circuit of the power transmitter comprising the primary coil 25. The object detector 43 is arranged to determine the reflection parameter (such as an impedance parameter) for a load of the output port of the object detector 43 formed by the primary coil 25 (and more generally the output circuit).

The object detector 43 comprises a signal generator 501 which is arranged to generate two carrier signals. The two carrier signals may substantially be single tone signals, i.e. may substantially be sine wave signals (in most embodiments, at least 90% of the energy of the signal is concentrated in the first harmonic).

The two carrier signals have a frequency offset with respect to each other. The frequency offset is typically substantially lower than the carrier frequency (of either carrier), say, at least 5, 10 or 100 times lower in many embodiments. The frequency offset is typically kept constant and may be predetermined in many situations.

Thus, the signal generator 501 generates two carrier signals that specifically may be two sinewave signals which have a frequency offset between them. In some embodiments, the frequency of the carriers may change while the frequency offset is being maintained constant (e.g. when determining a frequency dependent reflection parameter based on a frequency sweep).

It will be appreciated that different approaches can be used to generate the linked carrier signals. For example, the signal generator 501 may comprise a signal source which may be an oscillator generating a first carrier to have a suitable frequency (or frequencies). The generated first carrier may be output as one of the two generated carrier signals and may in addition be fed to a modulator which may perform a single sideband suppressed carrier modulation to modulate the first carrier by a modulation signal. The modulation signal is a generated as a sine wave signal (a tone) with a frequency equal to the desired offset frequency. The result of the modulation is thus a second carrier signal at a frequency which is offset from the first carrier by a frequency offset corresponding to the frequency of the modulation signal.

Thus, the signal generator 501 may generate a first carrier signal with a frequency of ω and a second carrier signal with a frequency of ω+ω_{mod} (or ω−ω_{mod}) where ω_{mod} is the offset frequency (and the modulation signal frequency).

The two generated signals are via two different parallel signal paths 503, 505 coupled to a mixer 507 in which the (modified) signals are mixed together. The two signal paths 503, 505 are substantially linear and thus the output of the two signal paths are signals with the same frequency as the original signals, i.e. as the first and second carrier signals. The mixing of the two output signals from the two signal paths 503, 505 thus produces a signal component with a frequency equal to the frequency offset. This frequency is typically much lower than the carrier frequencies, and is typically constant. Further, the amplitude and phase of the generated component is dependent on the amplitude and phase changes of the individual paths.

In the system, a first signal path includes the load (i.e. the output circuit/the primary coil 25) and the resulting output signal from the first signal path 503 is thus dependent on the amplitude and phase properties of the loading provided by this load. The second signal path 505 is generated as a reference path which does not include the load and which thus is independent of this. Furthermore, the reference path is designed to provide a transfer function (i.e. a phase and amplitude change) which is as similar to the transfer function of the information path (without the impact of the port) as is possible. Thus, the modulation frequency component at the output of the mixer provides information of the difference between the two signal paths and thus provides information on the load properties (and thus the reflection parameter) for the load.

The mixer 507 is coupled to a first detector 509 which evaluates the mixer output signal to determine the reflection parameter. Specifically, it may evaluate the modulation frequency component and determine a phase and amplitude of the load (the complex impedance of the primary coil 25) from the amplitude and phase of the modulation frequency component.

The first detector 509 is accordingly arranged to determine a reflection parameter for the output circuit comprising the primary coil 25 (the load) in response to the mixed signal received from the mixer 507. The first detector 509 is coupled to a second detector 511 which is arranged to detect the presence of an object in response to the reflection parameter. For example, the reflection parameter values typically encountered when no object is present may be known and the second detector 511 may compare the determined value to such reference values and determine that a foreign object is present if the difference exceeds a given threshold.

In the described approach, the first signal path 503, which will also be referred to as the information path, comprises a circulator 513 having at least three ports.

For a circulator, the ports form a circular arrangement with each port having a previous port and one subsequent port. The energy incident on a given port is forwarded/transmitted to the subsequent port in the arrangement but is blocked (or heavily attenuated) with respect to the previous port. For example, if a signal source is provided to a port, the signal will be forwarded to the subsequent port but there will be no signal component reaching the previous port. When a signal is output from a port to a load having an impedance different from the reference impedance, a reflected signal will reflect back to the port where it will be forwarded to the subsequent port but blocked from the previous port. Thus, the output signal of a given port corresponds to the energy incident on the previous port (whether from a reflection or a directly injected signal). The ports are arranged circularly so that each port functions both as a subsequent port and a previous port. Each port may simultaneously be considered a signal source (for the signal forwarded from the previous port) and a signal sink (for the reflected signal and/or directly injected signal. These signal components are forwarded to the subsequent port).

The ports have an output impedance corresponding to a characteristics impedance, which is typically resistive. Typical values of the reference impedance are 50Ω or 70Ω. The signal level at a given port may be seen as a combination of a forwarded signal and a reflected signal. For a passive loading of a port, the reflected signal depends on the deviation of the impedance of the passive load from the reference impedance. Specifically, a reflection coefficient may be given by:

$$r = \frac{{Z}_{L} - {Z}_{o}}{{Z}_{L} + {Z}_{o}}$$

where Z_{L} is the load impedance and Zₒ is the reference impedance (e.g. 50Ω).

The reflection coefficient (which is a complex value) indicates the amount of a forward signal from the port that is reflected to the port by the passive load. For a circulator, the forward signal is that resulting from the previous port and the reflected signal is forwarded to the subsequent port. Thus, the reflection coefficient indicates the amount (and phase) of the signal incident on the previous port that is reflected to the subsequent port by a passive load of the current port.

Specifically, for a passive load equal to the reference impedance, no signal from the previous port is forwarded to the next port whereas for an open circuit or short-circuit the entire signal of the previous port is forwarded to the following port (but with a 0° or 180°) phase difference.

Circulators are predominantly known from, and used in, microwave applications.

In the system of FIG. 5, the first signal path 503 comprises a circulator 513 which on a first port receives (directly or indirectly, e.g. via suitable amplification, impedance matching, power splitting, and/or filtering circuitry) the first carrier signal.

A second port, which is the subsequent port to the first port, is coupled to the unknown load, i.e., it is coupled to the output circuit of the power transmitter, and specifically to the primary coil 25 in the specific example. The signal from the first port, i.e. the first carrier signal is thus fed to the load by the output circuit. The reflected signal is by the circulator forwarded to the third port of the circulator 513 (the third port being a subsequent port of the second port).

Thus, if the unknown load is equal to the reference impedance, the output of the third port is zero. However, if the unknown load is different from the reference impedance, the output of the third port will be a signal that reflects the impedance of the unknown load. Specifically, it will have a phase and amplitude which depends on the impedance of the load (but will have the same frequency as the input frequency since the circulator (and load) are substantially linear components).

Indeed, the output signal of the third port Vₘ₁ may be given as a function of the first carrier signal V_{c1}:

$${V}_{m 1} = \frac{{Z}_{L} - {Z}_{o}}{{Z}_{L} + {Z}_{o}} {V}_{c 1}$$

(It will be appreciated that the equations may be modified as appropriate to account for amplification, attenuations, level shifting etc.).

Thus, the output of the third port of the first circulator 513 is a signal which corresponds to the first carrier signal but modified by the unknown load provided by the output circuit and specifically the primary coil 25. Specifically, the output of the third port outputs the reflected signal incident on the second port.

The third port of the circulator 513 is coupled to the mixer 507 which accordingly is fed the reflected signal on one of its mixer inputs.

In some embodiments, the first circulator 513 may be a three port circulator and thus may comprise no further ports. This may in particular be suitable for scenarios wherein the mixer can be designed to be guarantee that the input impedance is very close to the reference impedance such that any reflections are sufficiently small. However, in other embodiments, the first circulator 513 may be a four port having the fourth port connected to a reference impedance. This may provide an efficient isolation of the signal generator 501 from the mixer 507 and may thus reduce the risk of any reflections or load variations provided by the mixer feeding back to the signal generator 501.

The second signal path 505 provides a reference path for the first signal path 503 (and is therefore be referred to as the reference path).

The second signal path 505 is coupled to the signal generator 501 from which it receives the second carrier signal. It further has an output which is coupled to a second mixer input of the mixer 507.

The second signal path 505 furthermore comprises a signal path equalizer 515 having a transfer function which correspond to a transfer function of at least a signal path from the first port to the third port of the first circulator 513. Thus, the signal path equalizer 515 equalizes at least part of the first signal path 503, and specifically equalizes the signal path through the first circulator 513.

The signal path equalizer 515 is specifically arranged to result in the signal path through the first signal path 503 and the second signal path 505 having the same phase response (except for possibly a 180° or 90° phase offset) for the load corresponding to a short circuit or open circuit, i.e. for a reflection coefficient of −1 for a short-circuit and +1 for an open-circuit).

In many embodiments, the signal path equalizer 515 is arranged to provide a frequency response transfer function which has a response matching the response of the frequency response transfer function of the first signal path 503 for a reflection coefficient of 1 (or −1) (apart for possibly a 180° phase offset and a fixed frequency independent gain/amplitude factor).

The reference path provides a second signal which may accordingly reflect all the signal processing provided by the first signal path 503 except for the effect of the load. In particular, it may provide the same processing as performed by the first circulator 513 involved in the signal path from the signal generator 501 to the mixer 507, as well as other circuitry that may be involved (e.g. if the first signal path 503 includes an amplifier, the same amplifier may be included in the second signal path 505). The reference path may specifically duplicate the circuitry of the first signal path 503 thereby effectively providing the same overall transfer function (e.g. same path length etc).

The signal path equalizer 515 may thus be arranged for the second signal path 505 to provide a transfer function which very closely matches that of the first signal path 503 for a reflection coefficient of 1 (or −1).

The output of the second signal path 505 will thus for a reflection coefficient of 1 (or −1) very closely correspond to that of the first signal path 503 with the exception of the frequency offset between the first and second carrier signals. The two signals are mixed together and may then be filtered to remove (attenuate) the mixing results not corresponding the frequency offset. Thus, the sum frequency, as well as any potential components at the original frequencies (due to potential DC bias) will be removed and only the offset frequency signal component will be output.

The remaining signal component has an amplitude and phase which depends on the impedance of the load. For a load having an impedance corresponding to the reference impedance, the amplitude will be zero, and for the load corresponding respectively to an open circuit and a short circuit, the amplitude will be maximum with the phases being 180° phase offset with respect to each other.

More specifically, the output of the first and second signal paths may be given as respectively:

V_{Reference}=A cos(w₁t)

V_{Information}=r·B cos(w₁t+w_{mod}t+φ)

where w₁ is the (angular) frequency of the first carriers signal, w_{mod} is the (angular) offset frequency, φ is a phase offset between the first and second carrier signal (which may for brevity be set to zero), A and B are the relative amplitude levels of the first signal path 503 and the second signal path 505, and r is the complex reflection coefficient.

These two signals may be mixed and the resulting signal components that are not at the offset frequency may be filtered out, thereby resulting in the following main signal component at the output of the mixer:

Vₘᵢₓₑᵣ=·AB COS(w_{mod}t+φ)

Thus, a mixer output signal in the form of a mixed signal is generated having a frequency equal to the offset frequency and with an amplitude and phase directly given by the reflection coefficient (which is a complex value), and thus by the load impedance. The mixer output is then fed to the first detector 509 which may proceed to determine the reflection parameter (e.g. it may directly determine the reflection coefficient or the impedance as will be known to the skilled person).

The described approach provides a highly accurate approach for detecting objects in a wireless power transfer system. In comparison to many existing system, such as those based on power loss estimation or on evaluating a quality factor of an output resonance circuit, the current approach may often provide a substantially more accurate detection. Furthermore, the approach may in many scenarios be implemented with a relatively low degree of complexity.

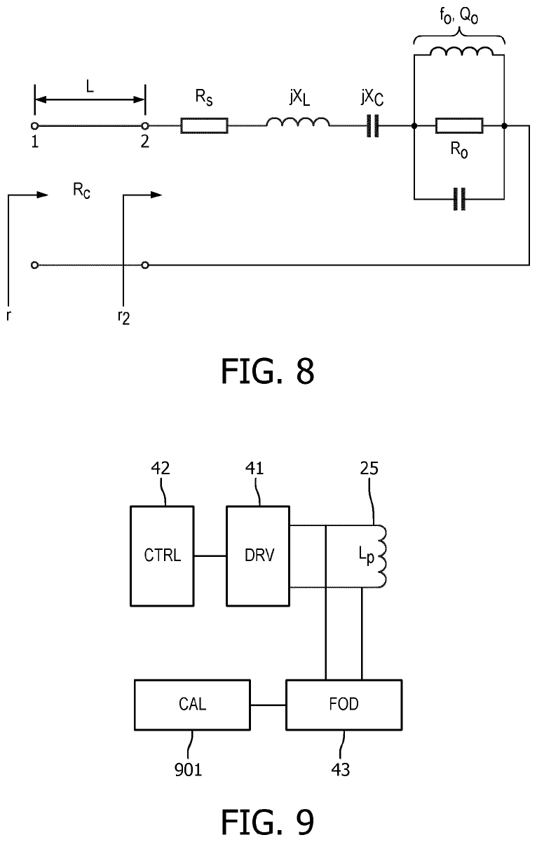

FIG. 6 illustrates an exemplary implementation of the system of FIG. 5 in accordance with some embodiments of the invention.

In the example, the object detector 43 comprises the signal generator 501 for generating the first carrier signal and the second carrier signal, the second carrier signal having a frequency offset relative to the first carrier signal; a first signal path 503 comprising a first (four port) circulator 601 having: a first port coupled to the signal generator 501 and arranged to receive the first carrier signal, the first port being an output for a(n optional) fourth port, a second port being an output of the first port and arranged to couple to the load; a third port being the output of the second port, and the (optional) fourth port being the output of the third part; a(n optional) first reference impedance coupled to the (optional) fourth port; the second signal path 505 comprising a first (three port) circulator 603 having a first port coupled to the frequency generator 501 and arranged to receive the second carrier signal, the first port being an output for a (an optional) third port of the first circulator 603, a second port being an output of the first port; and the (optional) third port being the output of the second port; a(n optional) second reference impedance coupled to the third port of the first (three port) circulator 603; a second (three port) circulator 605 having a first port being the output of a(n optional) third port of the second (three port) circulator 605 and being coupled to the second port of the second (three port) circulator 605, a second port being an output of the first port; and the (optional) third port being the output of the second port; a(n optional) third reference impedance coupled to the (optional) third port of the second (three port) circulator 605; a first mixer 507 coupled to the third port of the first (four port) circulator 601 and to the second port of the second (three port) circulator 605 and arranged to generate a mixed signal by mixing a first signal from the third port of the first (four port) circulator 601 and a second signal from the second port of the second (three port) circulator 605; a first detector 509 for determining the reflection parameter of the load in response to the mixed signal; and a second detector 511 (not shown in FIG. 6) for detecting a presence of an object in response to the reflection parameter.

In the example of FIG. 6, the signal path equalizer 515 thus comprises two circulators 603, 605 coupled in a cascade. The second signal carrier is fed to the first port P1A of the first circulator 603 and thus first passes from the first port P1A to the second port P2A. It is then fed to the first port P1B of the second circulator 605 and thus it subsequently passes from the first port P1B to the second port P2B of the second circulator 605. It is then fed from the second port P2B of the second circulator 605 to the mixer 507.

In the system of FIG. 6 both the first carrier signal and the second carrier signal thus reach the mixer 507 after having passed through two circulator stages, i.e. between two port-to-port circuits of the circulators. The circulators may be designed to be identical, or at least to have identical stages between the relevant ports, and accordingly the signal paths for the two signals are substantially identical except for the presence of the load. This provides a highly efficient way of balancing the paths such that the impact of the signal paths on the generated mixed signal is substantially limited to the effect of the load. This may result in a substantially more accurate detection.

It will be appreciated that whereas the path through two circulator stages in FIG. 6 is achieved by using two three (or more) port circulators, this is not essential. For example, in some embodiments, a cascade of two two-ports or e.g. a cascade of two four-ports could be used.

Indeed, in some embodiments, the signal path equalizer 515 may not implement full circulators but may e.g. only implement two port stages (together with suitable termination, e.g. a circulator stage and the input circuit of the following stage as well as a reference impedance termination may be implemented).

However, whereas other approaches for providing a series coupling of two circulator stages closely matching those of the first signal path 503 may be used in different approaches, the approach of using two three (or more) circulators as in the example of FIG. 6 may in many embodiments and scenarios provide an advantageous approach.

In particular, the additional port(s) and termination using a reference impedance may effectively attenuate or even block reflections such that these are not fed back to e.g. the signal generator 501, the previous circulator e.g. Thus, it may provide improved and more predictable performance and may e.g. reduce the requirements on other circuits (for example the requirement for impedance matching by the mixer 507). Further, it may ensure that the circuits making up the circulators operate at substantially the same operating point as the circuitry of the first four port circulator 601. These features may result in an even better matching between the different signal paths.

In the system of FIGS. 5 and 6, the circulators are active circulators. Specifically, a circulator stage between a first port and a second port may comprise an amplification element. The circulator stages may specifically be built using discrete components rather than distributed components. Thus, the circulators are not built using waveguides, transmission lines etc. as is known from microwave circuits but are rather built using discrete components such as resistors, capacitors, transistors, operational-amplifiers (op-amps) etc.

In the active circulators, a circulator stage connects a first port and a second port and is designed such that the two ports have a reference impedance, such as e.g. 50Ω. Further, each stage is formed such that the incident signal on the first port is fed to the second port whereas substantially no signal is fed back to the first port from the second port. Further, the gain from a previous circulator stage to the second port is substantially zero unless this signal is reflected by the load of the first port.

The circulators may specifically be generated using the approach disclosed in Wenzel C(1991), Low Frequency Circulator/Isolator Uses No Ferrite or Magnet, RF Design.

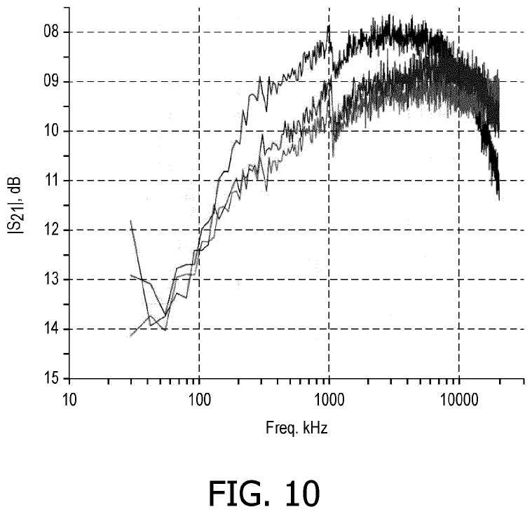

An example of such a circulator is illustrated in FIG. 7. In the exemplary active circulator, the resistor values are selected very carefully to provide the desired results. Specifically, the following relationship holds:

R2=3.236·R1.

For the given circuit, this results in an output/input impedance of all ports of R1/2 as well as a voltage gain for incident signals of Vₒ=2·Vᵢ which for a characteristic load impedance of a port is divided by two resulting in the desired Vₒ=Vᵢ. Furthermore, the op-amps ensure a very high reverse isolation. Further, the circuit does not forward any signal from a previous stage unless this is reflected due to the load of the current port not being equal to the reference impedance.

Specifically, a network analysis of the circuit of FIG. 7 will demonstrate that if a voltage source V_{P1} is fed to the first port P1, and an impedance Z_{L} is coupled to port P2, then the output signal on P3 (when this is terminated by the reference impedance equal to R1/2) is given by:

$${V}_{P 3} = \frac{{Z}_{L} - \frac{{R}_{1}}{2}}{{Z}_{L} + \frac{{R}_{1}}{2}} {V}_{P 1}$$

Thus, the output on port 3 is indeed the reflected signal as desired.

In the example of FIGS. 5 and 6, the circulators are specifically implemented as such Wenzel type active circulators formed by signal feedforward elements between subsequent ports. These signal feedforward elements are substantially identical for all circulators and thus provide substantially identical behavior.

A particular advantage of the active circulator approach is that it allows the principle of a circulator to be used at relatively low frequencies, and thus may specifically be very advantageous for foreign object detection in a wireless power transfer system. Indeed, in the described system, the frequencies of the first and second carrier signals are much lower than microwave frequencies, and are specifically in many embodiments not above 10 MHz, or indeed not above 5 MHz. In the specific example, the carrier signals are generated to have frequencies in the range from 500 kHz (inclusive) to 10 MHz (inclusive). This frequency range is particularly advantageous as it is sufficiently high to provide accurate detection and reliable performance while at the same time providing a frequency separation from the power transfer signal which is typically not above 200 kHz. It furthermore facilitates implementation and reduces the significance of parasitic components and irregularities. In the specific example, the carrier signals have frequencies of around 1 MHz.

The first detector 509 is arranged to determine the reflection parameter for the for the load. The reflection parameter may be any parameter indicative of the reflection from the load, and specifically may be any parameter indicative of the reflection coefficient or impedance of the load coupled to port 2 of the first circulator 513.

In some embodiments, the first detector 509 may be an analogue detector which e.g. generates in-phase and quadrature components for the signal from the mixer 507. These values may for example directly be indicative of the reflection coefficient, and thus may directly be indicative of the impedance of the load.

Thus, in some embodiments, the first detector 509 may generate (low pass filtered) quadrature and in-phase components by multiplying the mixer signal by respectively e.g. cos(w_{mod} t) and

$$cos ( {w}_{m o d} t + \frac{π}{2} )$$

and low pass filtering the result. The result is respectively an in-phase (I) and quadrature (Q) value which reflects the impedance of the load.

The I and Q values may be fed to the second detector 511 which may determine whether a foreign object is present or not based on the received values. As a low complexity example, a calibration process may be performed when a user indicates that no foreign object is present. The resulting I and Q values may be stored. Subsequently, during operation, the generated I and Q values may be compared to the stored values and if the difference (according to any suitable difference measure and criterion) is too large, this may be considered to be due to the presence of a foreign object and accordingly a detection is triggered.

In many embodiments, at least part of the processing will however be performed in the digital domain. For example, the output of the mixer may be digitized and the remaining processing may be performed in the digital domain. As another example, the I and Q values may be digitized for further processing. It will be appreciated that the above described processing and evaluation may equally be performed in the digital domain. However, in addition, the digitization typically allows more complex processing to be performed (examples of which will be described later).

The previous description has mainly described the approach for a detection based on measurements at a single frequency. This may in some embodiments allow a low complexity approach while still providing a sufficiently high accuracy of detection.

However, in many embodiments, the signal generator 501 is arranged to generate the first and second carrier signals as varied and specifically swept frequency carrier signals, and measurements of the reflection parameter may be made for different frequencies. Thus, the impedance/reflection parameter may e.g. be determined for a suitable frequency interval.

The frequency sweep is performed with the first and second carrier signal being linked, i.e. the frequencies of the two signals are modified in the same way. Thus, the frequency sweep is such that the offset frequency between the first and second signal carrier is maintained constant while the actual frequencies are varied.

This may for example be achieved by the first carrier signal being generated by a variable oscillator (such as a DDS or a VCO) with the second carrier signal being generated by a single sideband suppressed carrier modulation of this signal by a signal having a frequency equal to the desired offset frequency.

The linking of the two carrier signals such that offset frequency is constant for different absolute frequencies results in the (filtered) output signal of the mixer 507 having a constant frequency independent of the actual carrier frequencies. Thus, the frequency of this signal is constant during the frequency sweep thereby facilitating the processing by the subsequent processing and specifically facilitating the detection operation.

The frequency interval covered is typically substantially lower than the frequencies of the carrier signals. For example, the frequency sweep is typically performed over an interval no more than 10% of the frequencies of the carrier signals. However, it will be appreciated that the exact design parameters depend on the preferences and requirements of the individual embodiment.

Similarly, the actual offset frequency selected will depend on the preferences and requirements of the individual embodiment, and specifically on the preferred frequency for performing the processing by the first detector 509 and the second detector 511. In many embodiments, the offset frequency may advantageously be at a relatively low frequency which however is not related to the frequency of the power transfer signal. For example, the offset frequency may be set in the range from around 10 kHz to 50 kHz.

In many embodiments, the offset frequency may advantageously be higher than the 1/f noise corner frequency of the semiconductor devices that are used to build the frequency mixer. This noise corner frequency will typically vary according to the circuit design of the mixer and what semiconductor devices are used to build it eg: bipolar transistors, mosfets, schottky diodes, tunnel/back diodes etc.

The determination of a frequency dependent reflection parameter may in many embodiments allow improved detection. In particular, it may provide additional information that may be used to perform the detection.

For example, as described with reference to FIG. 4, the receive circuit of the power receiver may be a resonance circuit having a first resonance frequency close to the power transfer signal frequency (i.e. a power transfer resonance) and a second resonance frequency at a substantially higher frequency, such as e.g. around 1 MHz.

The object detector 43 may determine a frequency dependent reflection parameter in a frequency interval of, say, 950 kHz to 1050 kHz. The object detector 43 may in such an example determine whether the power receiver is present, and/or e.g. how closely it is coupled, in response to the frequency response for the reflection parameter. In particular, the contribution from the power receiver will show a strong peak around the second resonance frequency for the receive circuit whereas such a behavior is highly unlikely for a foreign object.

Further, in many embodiments, the additional information may be used to more accurately evaluate the loading of the power transfer signal thereby allowing improved detection.

For example, in some embodiments the second detector 511 may be arranged to determine an electrical model for the loading of the transmitter coil 103 based on the frequency dependent reflection parameter. The model may be determined by determining component parameters/values for an electric circuit model such that this matches the measured reflection parameter. The resulting component parameters/values may then by the second detector 511 be compared to expected component parameters/values for the situation where no foreign object is present. If the component values differ too much (in accordance with any suitable measure), it may be considered that a foreign object has been detected.

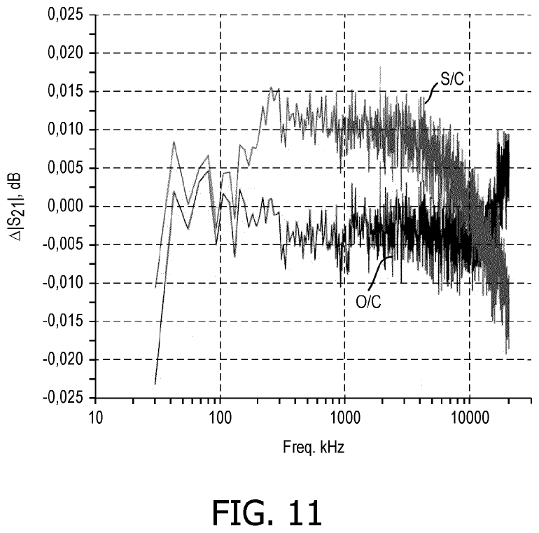

It will be appreciated that different models may be used in different embodiments. However, a particularly efficient model in many embodiments may be a lossy Foster reactance model such as is e.g. disclosed in Kajfez D, Deembedding of Lossy Foster Networks, IEEE Transactions on Microwave Theory and Techniques, MTT-53(10), 2005, 3199-3205. An example of a lossy Foster reactance model is illustrated in FIG. 8.

Thus, specifically, the simultaneous measurement of both phase and amplitude information for the load permits extraction of an accurate and compact model of the complete wireless power system. The use of the lossy Foster reactance model to determine the properties of the secondary Qi standard resonance may provide much higher accuracy in the determined parameter, and may for example allow a much more accurate determination of e.g. the unloaded Quality factor (Qₒ) for the typically encountered Qₒ values, less than one hundred. Such an approach may e.g. provide more accurate results than a magnitude only 3 dB insertion loss measurement approach which is often encountered but which is also only accurate and appropriate for resonators with values of Qₒ far above one hundred.

The lossy Foster reactance network shown in FIG. 8 comprises a length of ideal (lossless) transmission line in the reference impedance of the measurement system (Zₒ) located at point ‘1’ in the figure. This causes a phase rotation of the complex reflection coefficient of the wireless power network to be characterized and is used to model the effects of wiring/interconnect between the object detector 43 and the load.

In the described example, the system being measured comprises the coupled primary (transmitter) and secondary (receiver) wireless power inductors, their associated capacitors, parasitics and (if present) any lossy foreign objects. All of this is located at point ‘2’ in FIG. 8. The series resistance (R_{L}) models loss in the coupling network to the secondary (Qi standard) resonance at 1 MHz (Ref. FIG. 4) while the parallel resistance (R_{O}) models loss in the resonator due to radiation and/or the impact of a lossy foreign object in the vicinity of the receiver unit. The inductor and capacitor connected in parallel with resistor R_{O} define the resonance frequency of the receiver unit with/without a lossy foreign object nearby.

The lossy Foster reactance network equivalent circuit will function correctly for values of Qₒ down into single digits and can be extended by the addition of a further parallel RLC circuit to cope with multiple circuit resonances that may be encountered with e.g. Qi standard compliant devices (primary resonance at ˜100 kHz and a secondary resonance at ˜1 MHz).

The lossy Foster reactance network equivalent circuit approach to Qₒ measurement also yields higher accuracy for high Quality factor resonators compared to e.g. the more commonly encountered Q-circle fitting methods. This also means that higher precision, and hence a better ability to determine the presence of foreign objects, will also be achieved if the primary Qi standard resonance around 100 kHz is also measured by the same approach.

The model parameters may for example be extracted from the measured complex reflection coefficient data in a two-step process as described in the above referenced article by Kajfez. First, a least squares minimization of the measured complex reflection coefficient data may be used to obtain starting values for the seven model parameters. Second, these values may then be used as the starting point for a simple optimization routine to further refine the values so as to obtain the best fit between the measured and modelled reflection coefficient data.

The following table provides examples of model component values that have been determined for a Qi standard receiver and charging pad with no foreign object present, as well as with a metallic Foil or a metallic Ring foreign object present.

| | No Foreign | Metallic Foil | Metallic Ring |
|---|---|---|---|
| Model Parameter | Object | Foreign Object | Foreign Object |
| Transmission-line | 3.105625 | 2.272345 | 2.724304 |
| time delay in | | | |
| nanoseconds | | | |
| Series Resistance | 2.761393 | 1.944612 | 1.624365 |
| (Rₛ) in Ohms | | | |
| Series Capacitance | −54.18011 | 0.1957069 | −61626.51 |
| in Nano-Farads | | | |
| Series Inductance | 20.68807 | 20.66176 | 19.77276 |
| in Micro-Henries | | | |
| Resonant Frequency | 0.9485191 | 1.009685 | 1.023554 |
| in MHz | | | |
| Unloaded Quality | 56.04283 | 5.079710 | 59.76671 |
| Factor | | | |
| Resonator Resistance | 1531.408 | 67.87581 | 660.8156 |
| (Rₒ) in Ohms | | | |
| Resonator Capacitance | 6.140491 | 11.79664 | 14.06334 |
| in Nano-Farads | | | |
| Resonator Inductance | 4.585060 | 2.106253 | 1.719216 |
| in Micro- Henries | | | |

As can be seen, significantly different component values are determined and the detection of the presence of a foreign object can be performed by comparing the current measured values to the expected values for no foreign object being present. If the difference is too high, a foreign object is considered to be detected.

In some embodiments, only a low complexity simple evaluation of one parameter may be used. For example, a foreign object may be considered to be detected if Ro is below, say, 1 kΩ. In other embodiments, more complex comparisons may be performed, such as for example a weighted summation of differences for a plurality (and typically all) of individual components.

In some embodiments, the object detector 43 may be arranged to adapt the model and/or the foreign object decision criterion based on information received from the power receiver. Specifically, the power transmitter may be arranged to receive circuit data from the power receiver which may describe elements of the receiving circuit of the power receiver. For example, the power receiver may indicate whether a second resonance capacitor is available, the value of any capacitors, the inductance of the secondary coil, the resonance frequency etc.

The second detector 511 may be arranged to adapt the model to reflect these values. For example, it may select between different predetermined models depending on which is considered to most closely match the specific configuration of the current power receiver, or it may e.g. provide limits for the component values for the generated model.

In some embodiments, the second detector 511 may instead use the information of the power receiver receive circuit when detecting whether a foreign object is present or not. For example, the power receiver may have suitable model parameters with no foreign objects present determined at time of manufacture and stored in non-volatile memory at the time of manufacture. These stored model parameters may then during operation be communicated to the power transmitter and compared against the extracted model parameters measured at that moment in time. Discrepancies between the expected and extracted model parameters indicate that a foreign object in addition to the power receiver is present.

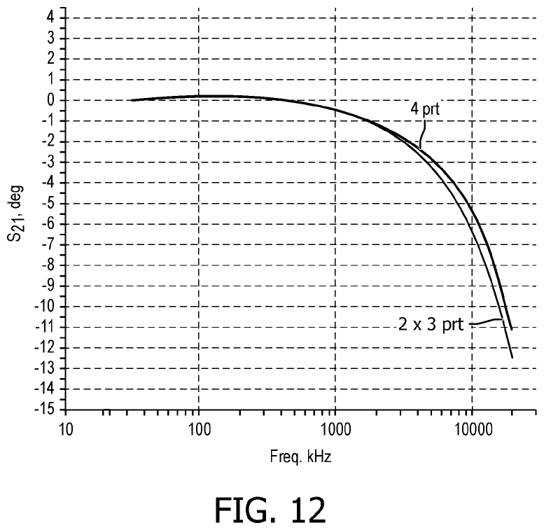

As illustrated in FIG. 9, the power transmitter may in some embodiments include a calibrator 901 arranged to calibrate the object detector 43. The calibrator 901 may be arranged to couple a known load to the second port of the first circulator 513 instead of the output circuit and to calibrate the object detector 43 in response to a parameter for the object detector 43 when the known load is coupled to the second port.

Indeed, a particular advantage of the approach of FIG. 5 is that it can be calibrated easily and effectively. Specifically, the output circuit representing the unknown load may be decoupled (disconnected) from the second port of the first circulator 513 and instead the port may be short-circuited or open-circuited. As the transfer function of the first signal path 503 is now ideally identical to that of the second signal path 505 (except for a fixed phase shift), the resulting signal being output from the mixer can directly provide an indication of any discrepancies. The object detector 43 may accordingly be calibrated.

For example, the output circuit may at the second port be replaced by a short circuit with the resulting phase variation in the resulting mixer output signal being measured and stored. The measured phase difference reflects the difference between the two paths and may accordingly be used to compensate subsequent measurements.

Specifically, the approach allows calibration to be performed using the generic Open-Short-Load calibration approach familiar from vector network analyzer measurements of Radio Frequency (RF) and Microwave/Millimetre-wave devices (ref. e.g. Dunsmore J(2007), Network Analyzer Basics Notes, Agilent Technologies) i.e. three known and widely spaced across the Smith chart complex impedances are measured with the object detector 43. The measured data is compared against the a-priori known complex impedance values and then the vector error correction coefficients needed to map the actual measured complex impedance data onto the known impedance data can be calculated explicitly.

Matched load, short-circuit and open-circuit terminations cover the extreme ranges and center position of the Smith chart and would be the ideal set of calibration impedances to use though others are possible. In addition to providing a means to determine presence of foreign objects across many different implemented foreign object detectors, due to spread and tolerance in component values as well as the effect of the specific charging circuitry, the calibration process also provides a means to enable traceability to International standards of RF impedance and determination of measurement uncertainties. Such features are absent from other methods of foreign object detection currently proposed.

It will be appreciated that whereas FIG. 4 illustrates that both the driver 41 and the object detector 43 is directly coupled to the output circuit/primary coil 25, the system may in many embodiments comprise functionality for separating or differentiate the power transfer and foreign object detection signals and operation. Such differentiation may e.g. be performed in the frequency domain (e.g. using filters) or in the time domain by using a time division between power transfer and foreign object detection.

In the latter case, the foreign object detection may e.g. only be performed when no power transfer is taking place. However, this is typically disadvantageous, as it is desired both that power transfer is continuous when active and that foreign object detection can be performed during a power transfer operation.

In the former case (separation in the frequency domain), the system may effectively include a diplexer circuit that connects the measurement port of the first circulator to the output circuit. The diplexer my comprise parallel connected lowpass and highpass (or a bandpass instead of the highpass) filter sections. The lowpass filter will pass the lower frequency drive signal (e.g at around 100 kHz) to the output circuit and will also block the higher frequencies of the first carrier signal from the object detector 43 from reaching the output of the driver.

The highpass (or bandpass) filter may be designed to pass the high frequency signal (e.g. 1 MHz) from the object detector 43 to the primary coil 25 and will at the same time reject (attenuate) the low frequency drive signal. Accordingly, the object detector 43 will only receive the reflection signal arising from the signal that the object detector 43 itself forwards to the output circuit.

In some implementations of the charging circuit, a full or half-bridge circuit may used to generate the drive signal which accordingly may be generated as a square wave signal. This may result in odd harmonics being generated and these could potentially fall within the measurement band of the object detector 43. In many embodiments, the measurement frequency band may be carefully selected to seek to avoid or reduce such a situation occurring. Alternatively or additionally, the drive signal may in some embodiments be generated to have a smoother behavior, e.g. a signal shape with less energy in harmonics may be generated.

In the main embodiment described with reference to FIGS. 6 and 7, two cascaded active three port circulators 603, 605 of the second signal path 505 are used to compensate/match one four port circulator 601 of the first signal path 503. Thus, it is desired that two cascaded three-port circulators have an identical magnitude/phase response to a four-port.

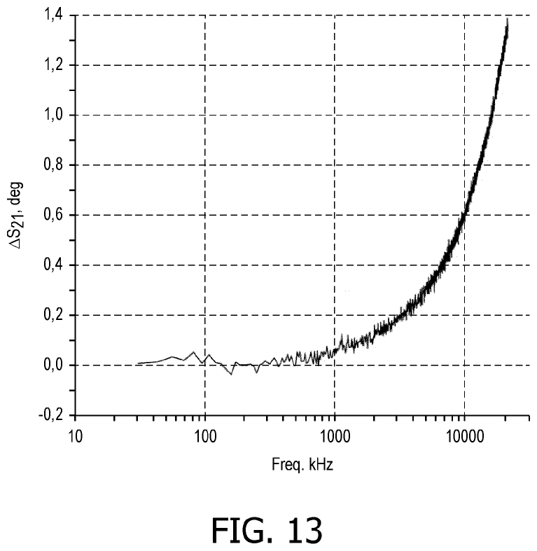

To demonstrate the feasibility of this approach, measurements have been made and the results are shown in FIGS. 10-13.

FIG. 10 shows the measured magnitude of the S21 parameter (forward transmission) for the following setups:

a. Two three port circulators cascaded where both of the 3-ports have port-3 terminated in the reference impedance
b. A single four-port circulator with Port-2 terminated in a Short-circuit and Port-4 terminated in the reference impedance
c. A single four-port circulator with Port-2 terminated in an Open-circuit and Port-4 terminated in the reference impedance

FIG. 11 illustrates the difference in dB between the S21 value measured for cascaded 3-port circulators versus the two 4-port circulator configurations. As can be seen the discrepancy between the measurements is in the milli-dB to tens of milli-dBs range, i.e. a very close match is achieved.

The measurements were made with a Hewlett-Packard 8753E Vector Network analyzer and a Hewlett-Packard 85033D 3.5 mm mechanical coaxial calibration kit. The uncertainty in the measurement data is around 0.3 dB which is actually larger than the difference (by some way) between the measured S21 values.

FIG. 12 illustrates the measured phase of the S21 parameter for the following:—

a. Two three port circulators cascaded where both of the 3-ports have port-3 terminated in the reference impedance
b. A single four-port circulator with Port-2 terminated in a Open-circuit and Port-4 terminated in the reference impedance

Finally, FIG. 13 illustrates the difference in degrees between the measured phase of the S21 parameter for the previous example. The measurement uncertainty for the phase of S21 is around 0.25 degrees and as can be seen this is larger than the measured phase differences out to around 3 MHz or so.

Thus, as demonstrated by these measurements, both the phase and magnitude matching of the cascaded 3-port circulators vs the four-port circulator is extremely good (indeed with a mismatch that is less than the actual uncertainty in the measured values) up to 3 MHz.

The data was generated by measuring the four-port circulator as a full 4-port device then numerically terminating ports 2 and 4 with ideal loads (open, short, matched termination); the three-port circulators were measured as three-port devices then the two 3×3 S-Parameter matrices were appropriately numerically terminated on the unused ports (ideal matched loads) and cascaded.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A power transmitter for a wireless power transfer system including a power receiver for receiving a power transfer from the power transmitter via a wireless inductive power signal;
the power transmitter comprising:
an output circuit comprising a transmit power inductor for generating the wireless inductive power signal;
an object detector for detection of an object extracting power from the power transfer signal;
wherein the object detector comprises:
a signal generator for generating a first carrier signal and a second carrier signal, the second carrier signal having a frequency offset relative to the first carrier signal;
a first signal path coupled to the signal generator so as to receive the first carrier signal, the first signal path comprising a first circulator having a first port coupled to the signal generator for receiving the first carrier signal and a second port coupled to the output circuit and a third port providing a reflected signal from the output circuit;
a second signal path coupled to the signal generator so as to receive the second carrier signal, the second signal path comprising a signal path equalizer having a transfer function corresponding to a transfer function of at least a signal path from the first port to the third port of the first circulator;
a mixer coupled to the first signal path and the second signal path and arranged to generate a mixed signal by mixing an output signal from the first signal path and an output signal from the second signal path;
a first detector for determining a reflection parameter for the output circuit in response to the mixed signal; and
a second detector for detecting a presence of the object in response to the reflection parameter.

2. The power transmitter of claim 1 wherein the signal path equalizer comprises at least two circulator stages coupled in cascade, a first circulator stage of the at least two circulator stages corresponding to a circulator stage from the first port to the second port of the first circulator and a second circulator stage of the at least two circulator stages corresponding to a circulator stage from the second port to the third port of the first circulator.

3. The power transmitter of claim 1 wherein the signal path equalizer comprises at least one circulator.

4. The power transmitter of claim 3 wherein the signal path equalizer comprises two cascade coupled circulators.

5. The power transmitter of claim 4 wherein the first circulator is a four port circulator having a reference impedance coupled to a fourth port and the two cascade coupled circulators are three port circulators each having a reference impedance coupled to a third port.

6. The power transmitter of claim 1 wherein the first circulator is an active circulator.

7. The power transmitter of claim 1 wherein the signal generator is arranged to generate the first and second carrier signals as a varied frequency carrier signals; and the first detector is arranged to determine the reflection parameter as a frequency dependent reflection parameter.

8. The power transmitter of claim 1 wherein the signal generator is arranged to generate the first carrier signal and the second carrier signal to not have a frequency exceeding 10 MHz.

9. The power transmitter of claim 1 wherein the second detector is arranged to determine component parameters for an electric circuit model in response to the reflection parameter; and to detect the presence of the object in response to the component parameters.

10. The power transmitter of claim 9 wherein the electric circuit model is a lossy Foster reactance model.

11. The power transmitter of claim 9 arranged to receive circuit data from the power receiver, the circuit data being indicative of a receiving circuit of the power receiver; and to determine at least one of the electric circuit model and a criterion for detecting the presence of the object in response to the circuit data received from the power receiver.

12. The power transmitter of claim 1 wherein a frequency of the power transfer signal is not above 200 kHz and a frequency of the first carrier signal is not below 500 kHz.

13. The power transmitter of claim 1 further comprising a calibrator arranged to couple a known load to the second port of the first circulator instead of the output circuit and to calibrate the object detector in response to a parameter of the object detector when the known load is coupled to the second port.

14. A wireless power transfer system comprising a power transmitter and a power receiver for receiving a power transfer from the power transmitter via a wireless inductive power signal;
the power transmitter comprising:
an output circuit comprising a transmit power inductor for generating the wireless inductive power signal;
an object detector for detection of an object extracting power from the power transfer signal;
wherein the object detector comprises:
a signal generator for generating a first carrier signal and a second carrier signal, the second carrier signal having a frequency offset relative to the first carrier signal;
a first signal path coupled to the signal generator so as to receive the first carrier signal, the first signal path comprising a first circulator having a first port coupled to the signal generator for receiving the first carrier signal and a second port coupled to the output circuit and a third port providing a reflected signal from the output circuit;
a second signal path coupled to the signal generator so as to receive the second carrier signal, the second signal path comprising a signal path equalizer having a transfer function corresponding to a transfer function of at least a signal path from the first port to the third port of the first circulator;
a mixer coupled to the first signal path and the second signal path and arranged to generate a mixed signal by mixing an output signal from the first signal path and an output signal from the second signal path;
a first detector for determining a reflection parameter for the output circuit in response to the mixed signal; and
a second detector for detecting a presence of the object in response to the reflection parameter.

15. A method of operation for a power transmitter for a wireless power transfer system including a power receiver for receiving a power transfer from the power transmitter via a wireless inductive power signal;
the power transmitter comprising:
an output circuit comprising a transmit power inductor for generating the wireless inductive power signal;
an object detector for detection of an object extracting power from the power transfer signal;
and the method comprising the object detector performing the steps of:
generating a first carrier signal and a second carrier signal, the second carrier signal having a frequency offset relative to the first carrier signal;
providing a first signal path coupled to the signal generator so as to receive the first carrier signal, the first signal path comprising a first circulator having a first port coupled to the signal generator for receiving the first carrier signal and a second port coupled to the output circuit and a third port providing a reflected signal from the output circuit;
providing a second signal path coupled to the signal generator so as to receive the second carrier signal, the second signal path comprising a signal path equalizer having a transfer function corresponding to a transfer function of at least a signal path from the first port to the third port of the first circulator;
generating a mixed signal by mixing an output signal from the first signal path and an output signal from the second signal path;
determining a reflection parameter for the output circuit in response to the mixed signal; and
detecting a presence of the object in response to the reflection parameter.
